(19) United States
(12) Patent Application Publication
(10) Pub. No.: US 2004/0167823 A1
(43) Pub. Date: Aug. 26, 2004

(54) Automated electronic payment system

(76) Inventors: Robert Alan Neely, Greensboro, NC (US); Michael Hilton Dawson, Ottawa (CA); Shelley Ng, Markham (CA)

Correspondence Address: MACCORD MASON PLLC, 300 N. GREENE STREET, SUITE 1600, P. O. BOX 2974, GREENSBORO, NC, 27402, US

(21) Appl. No.: 10/426,379

(22) Filed: Apr. 30, 2003

Related U.S. Application Data
(63) Continuation-in-part of application No. 10/255,293, filed on Sep. 26, 2002.
Application No. 10/255,293 is a continuation of application No. 09/535,334, filed on Mar. 27, 2000, now abandoned.
Application No. 09/535,334 is a continuation of application No. 08/925,344, filed on Sep. 8, 1997, now Pat. No. 6,044,362.

(51) Int. Cl. G06F 17/60

(52) U.S. Cl. 705/26

(57) ABSTRACT

An automated electronic payment system wherein customer/buyer payment instructions are sent from a customer/buyer to a payment source, the system including: (a) invoice presentation means adapted to present billing data from an invoicer/seller for customer/buyer review and to request payment from the customer/buyer; (b) an electronic customer/buyer payment interface: (i) for receiving the billing data and the request for payment from the invoicer/seller; (ii) for providing the billing data for customer/buyer review and the request for payment to the customer/buyer; (iii) for receiving customer/buyer payment instructions from the customer/buyer in response to the request for payment; (iv) for transmitting the customer/buyer payment instructions from the customer/buyer to the payment source, the payment instructions including at least an invoicer/seller deposit account number, a payment amount and a customer/buyer payment account number; and (v) for providing remittance data associated with the payment from the customer/buyer to the invoicer/seller; and (c) an automated electronic invoicing and payment system for providing remote customer/buyer review of automated billing from an invoicer/seller, wherein the customer/buyer payment instructions are sent from the customer/buyer directly to the invoicer/seller.

### CROSS-REFERENCE TO RELATED APPLICATIONS

The present application is a Continuation-in-Part of U.S. application Ser. No. 10/255,293, filed Sep. 26, 2002 which was a Continuation of U.S. application Ser. No. 09/535,334, filed Mar. 27, 2000, now abandoned, which was a Continuation of U.S. application Ser. No. 08/925,344, filed Sep. 8, 1997, now U.S. Pat. No. 6,044,362, issued Mar. 28, 2000.

### BACKGROUND OF THE INVENTION

(1) Field of the Invention

The present invention relates generally to automated electronic billing and payment systems and, more particularly, to an automated electronic payment system for providing an electronic payment to a biller.

(2) Description of the Prior Art

Invoicing and payment processing has always been a very labor intensive and paper intensive process. Typically the process has involved an invoicer/seller, usually a business, who prepares an invoice detailing the goods and services provided and the charges therefor. The invoice is mailed to a customer/buyer who verifies the correctness of the invoice and returns a payment coupon of some type along with a paper check to the invoicer/seller. The invoicer/seller then submits the paper check to its bank for payment through, for example, the Automated Clearing House (ACH) network. Other similar payment systems include writing a credit card number and endorsing and preauthorization to draft an account on a monthly basis up to preset limits, such as regularly paying utility bills from a checking account.

Attempts have been made to automate this process through the use of third party service providers who receive and transmit between the invoicer/seller and the banks involved electronic information relating to payments due from a customer/buyer. Although these systems appear to streamline the process, they, in fact, may add a great deal of complexity and no small amount of expense to the process. Such electronic systems are described in U.S. Pat. No. 5,383,113, issued to Kight et al.; U.S. Pat. No. 5,283,829, issued to Anderson et al.; U.S. Pat. No. 5,220,501, issued to Lawlor et al.; and U.S. Pat. No. 5,465,206, issued to Hilt et al., the disclosures of which are hereby incorporated by reference in their entireties.

However, paper systems require that the invoice be presented to the customer/buyer and, in addition, require that either that the customer/buyer present the paper check to the invoicer/seller's bank either directly to the invoicer/seller or indirectly to a lock box before payment is made from the customer/byuer's bank to the invoicer/seller's bank.

Moreover, electronic systems require that the invoice be presented to a third party service provider and then to the customer or to the customer/buyer's bank and then to the customer/buyer and, in addition, require that the customer/buyer present the electronic payment back to the third party service provider before payment is made from the customer/buyer's bank to the invoicer/seller's bank.

Thus, there exists a need for a simple, straight forward system of automated electronic payment that directly involves the invoicer/seller and the customer/buyer while, at the same time, does not require a third party service provider and can be customized to include pre-approved payments for invoices of a certain type or under a certain dollar threshold. Moreover, the system should be capable of accommodating a plurality of invoicers/sellers related to a customer/buyer.

### SUMMARY OF THE INVENTION

The present invention is directed to an automated electronic payment system wherein customer/buyer payment instructions are sent from a customer/buyer to a payment source, the system comprising: (a) invoice presentation means adapted to present billing data from an invoicer/seller for customer/buyer review and to request payment from the customer/buyer; (b)an electronic customer/buyer payment interface having: (i) means for receiving the billing data and the request for payment from the invoicer/seller; (ii) means for providing the billing data for customer/buyer review and the request for payment to the customer/buyer; (iii) means for receiving customer/buyer payment instructions from the customer/buyer in response to the request for payment; (iv) means for transmitting the customer/buyer payment instructions from the customer/buyer to the payment source, the payment instructions including at least an invoicer/seller deposit account number, a payment amount and a customer/buyer payment account number; and (v) provide remittance data associated with the payment from the customer/buyer to the invoicer/seller; and (c) an automated electronic invoicing and payment system for providing remote customer/buyer review of automated billing from an invoicer/seller, wherein the customer/buyer payment instructions are sent from the customer/buyer directly to the invoicer/seller.

In the preferred embodiment of the present invention, the payment source may be a clearing house, which may be a courier and/or a payment network. The payment instructions may include transmission date and/or an amount to draft from customer associated financial institution, and/or account information associated with the customer/buyer from which to draft payment, and/or account information associated with the invoicer from which to deposit payment.

The billing data may include invoicer/seller billing information, and/or a due date, and/or an amount due. The billing data may also include a list of goods or services provided during a billing period, and/or a late charge, and/or account information, and/or customer/buyer information. The customer/buyer information may include customer name, and/or a customer address, and/or account information for the customer. The billing data may include a customer/buyer account identifier, an invoicer/seller identifier and/or an invoice identifier.

In the preferred embodiment of the present invention, the invoice presentation means includes invoice information relating to customer/buyer bills and may include account information relating to financial institutions associated with the customer/buyer from which payments may be drafted and to which payments would be deposited. The invoice presentation means may further include preauthorized payment instructions for automated payment of a billing amount set out in said billing information from an account set out in said account information. The request for payment instructions from said invoice presentation means may query the customer/buyer if the preauthorized payment instructions are desired for the billing data presented. The request for payment instructions from said invoice presentation means may query the customer/buyer if the preauthorized payment instructions need modification for the billing data presented. The customer/buyer payment interface may include an editor for modifying the preauthorized payment instructions.

In the preferred embodiment of the present invention, the account information may include account information from a plurality of financial institutions and the request for payment queries the customer to select the financial institution from which to draft payment for an associated customer/buyer bill, and/or a preauthorized default identifying the financial institution from which to draft payment for said associated customer/buyer bill. The electronic customer/buyer payment interface may be adapted to receive a customer/buyer input to accept the preauthorized default, and/or may be adapted to receive a customer/buyer input to modify the preauthorized default.

The request for payment may include billing information selected from the group consisting of amount due, due date of payment, and invoice detailed information. The customer/buyer payment interface may be adapted to modify the billing information to change one or more of the group consisting of amount due, time of payment and account from which to draft payment. The billing data may include notices for the customer and/or control information.

In the preferred embodiment of the present invention, the means for receiving billing data includes at least one of the group consisting of an .xml file, an .edi file, a text delimited, and a web e form. The means for providing the billing data includes at least one of the group consisting of an XML file, an EDI file, a text file, and a web e-form. The means for receiving customer/buyer payment instructions includes at least one of the group consisting of an XML file, an EDI file, a text file, and a web e-form. The means for transmitting the customer/buyer payment instructions or receiving billing data includes a network and a network interface. The network and the network interface may include a public network, which may be the Internet. The system may also include a private network, which may include a VPN and/or a VAN.

In the preferred embodiment of the present invention, the means for providing remittance data includes at least one of the group consisting of an XML file, an EDI file, a text file, and a web e-form, and may further include a network and a network interface. The network and the network interface may include a public network, which may include the Internet. The network and the network interface may include a private network, which may include a VPN and/or a VAN.

Accordingly, one aspect of the present invention is to provide an automated electronic payment system wherein customer/buyer payment instructions are sent from a customer/buyer to a payment source, the system comprising: (a) invoice presentation means adapted to present billing data from an invoicer/seller for customer/buyer review and to request payment from the customer/buyer; and (b) an electronic customer/buyer payment interface having: (i) means for receiving the billing data and the request for payment from the invoicer/seller; (ii) means for providing the billing data for customer/buyer review and the request for payment to the customer/buyer; (iii) means for receiving customer/buyer payment instructions from the customer/buyer in response to the request for payment; and (iv) means for transmitting the customer/buyer payment instructions from the customer/buyer to the payment source, the payment instructions including at least an invoicer/seller deposit account number, a payment amount and a customer/buyer payment account number.

Another aspect of the present invention is to provide an electronic customer/buyer payment interface for an automated electronic payment system for providing customer/buyer review of billing from an invoicer/seller, said system comprising: (a) means for receiving billing data and a request for payment from said invoicer/seller; (b) means for providing the billing data for customer/buyer review and the request for payment to the customer/buyer; (c) means for receiving customer/buyer payment instructions from the customer/buyer in response to the request for payment; (d) means for transmitting the customer/buyer payment instructions from the customer/buyer to a payment source, said payment instructions including at least a invoicer/seller deposit account number, a payment amount and a customer/buyer payment account number; and (e) means for providing remittance data associated with the payment from the customer/buyer to said invoicer/seller.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic representation of various prior art invoicing systems;

FIG. 2 is a schematic representation of a method for electronic invoicing and paying performed according to the present invention; and

FIGS. 3A and 3B are schematic representations of an electronic invoicing and payment system constructed according to the present invention.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

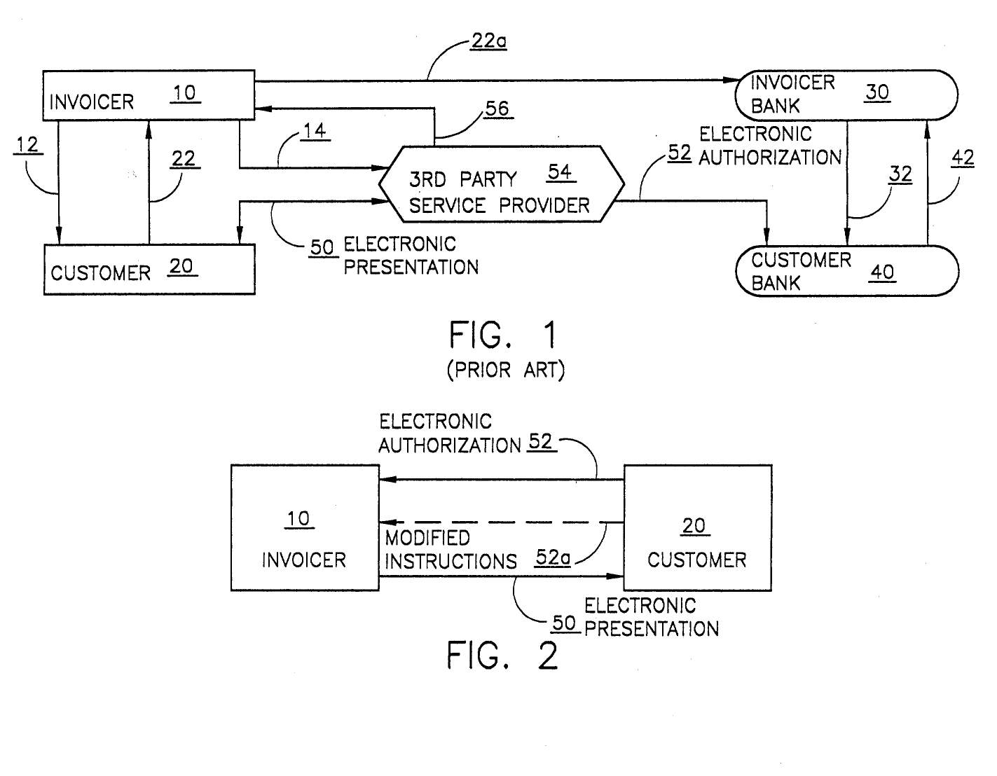

Referring now to the drawings in general and FIG. 1 in particular, it will be understood that the illustrations are for the purpose of describing a preferred embodiment of the invention and are not intended to limit the invention thereto. Turning to FIG. 1, there is illustrated the current process used for paper invoice payment and automated invoice payment using a third party service provider.

In the case of the paper invoice process, an invoicer 10 prepares a paper invoice 12 which is sent via mail to customer 20. After verifying that the invoice is correct customer 20 prepares a paper check 22 and returns the paper check 22 to invoicer 10. Invoicer 10 then credits the account of customer 20 and submits check 22 with its other business receipts to invoicer bank 30. Invoicer bank 30 then interacts with customer bank 40 via the well-known ACH network to demand the funds from customer's checking account and deposit those funds into the invoicer's checking account. This interaction follows a conventional, well known process represented by 32, 42.

As discussed above, some period may elapse before invoicer 10 receives check 22 from customer 20. This process can be expedited somewhat if the check is sent directly from customer 20 to invoicer bank 30. This “lock box” process takes place through the use of a post office box address on the invoice, which sends the check 22 to invoicer bank 30 even though the address on the invoice 12 may show the name of invoicer 10. In this modified process, after receiving check 22, invoicer bank 30 will still go through the ACH network 32,42 before funds are credited to invoicer's account.

In an attempt to automate this process, third party service providers 50 have entered the scene. Here invoicer 10 transmits an electronic data stream 14 to service provider 50 containing all of the information that normally is contained in a paper invoice. There is then an electronic communication 52 between service provider 50 and customer 20 for the purpose of notifying customer 20 of the pending charge and, in some cases, allowing the customer to approve of the charge against its accounts. Service provider 50 then transmits payment authorization 54 to customer bank 40. At the same time service provider 50 may also transmit a message 56 to invoicer 10 with notification of the payment authorization 54.

After receiving authorization 54, customer bank 40 then sends payment to invoicer bank 30 through conventional channels.

The non-bank service provider 50 may also be granted access to the ACH network to direct draft via PPD customer bank 40 on behalf of customer 20. In this case, service provider 50 may receive funds from the customer into the service provider checking account and then disperse those funds to invoicer 10.

As can be seen from the complexity of FIG. 1, both the conventional paper invoice process and the third party service provider process are cumbersome, and time/labor intensive.

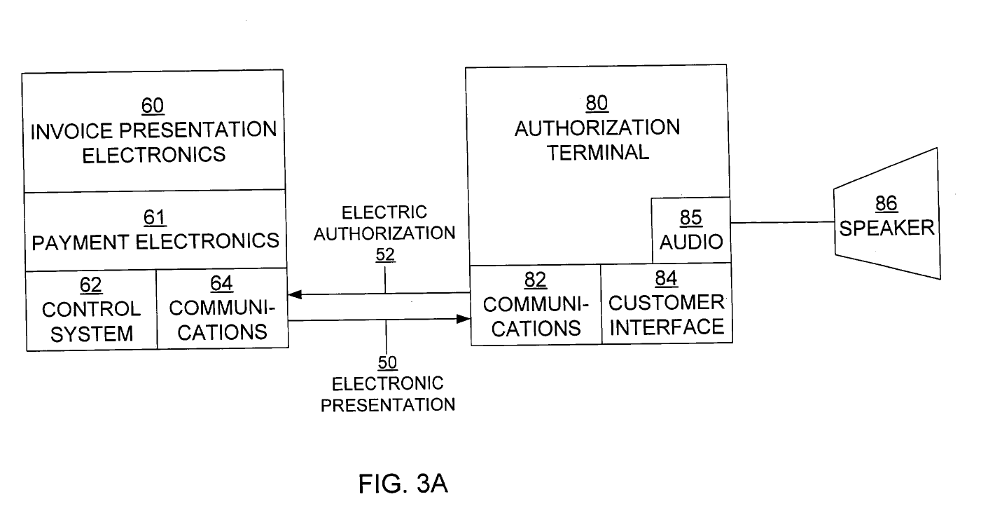

As best seen in FIG. 2, a method for electronic invoicing and paying is shown constructed according to the present invention. The method starts with the electronic presentment 50 of an invoice to customer/buyer 20. It should be understood that the term “presentment” as used herein does not include the specialized definition normally associated with commercial paper, i.e., the production of a negotiable instrument to a drawee. Rather, the term refers to providing via electronic means an “invoice” containing at least the same customer/buyer billing data typically included on a paper invoice. This electronic presentment may take place through the use of an Internet website, a bank ATM machine or through the use of a stand alone kiosk.

In a preferred embodiment, the invoice would also include, in addition to normal billing data, a request for payment instructions. This request provides the customer/buyer the opportunity to select either the bank account from which the invoice will be paid, or it provides the customer/buyer with the option to pay via a debit card, credit card, ATM, stored value card or some source of funds.

The invoice would include billing data such as the customer/buyer name, address, account number and e-mail address. The invoice may further include bill data typically included with a paper invoice to include the period covered by the invoice, a detail of the goods/services covered by the invoice, a total amount due and a payment due date.

In addition to the typical invoice information, the electronic invoice presentment may also include customer/buyer notices relating to changes in credit terms and the like. Invoicer/seller 10 may also include sales and promotional materials informing customer/buyer 20 of new products or sales on existing products.

After electronic invoice presentment 50, the customer/buyer provides an electronic authorization 52 to a payment source permitting customer/buyer's account to be charged. This step eliminates the time and expense of preparing and mailing a paper check. Thus, invoicer/seller's 10 bank account could be credited to debit customer/buyer's bank account in as little as one day as opposed to the period required to receive a paper check 22.

The information included in this electronic authorization could include the invoice account number and an associated customer/buyer payment account. In a preferred embodiment, both these items of information are submitted simultaneously with the authorization. When pre-arranged instructions are made this information does not need to re-submitted each time.

Prior to providing the authorization for payment, customer/buyer 20 is provided with a number of options for changing the payment instructions to create modified payment instruction 52a. These modifications can range from no modification at all in accepting all the payment terms contained in the presentment. Alternatively, customer/buyer 20 may be provided with any combination of the following options:

1) The customer/buyer may pay less than the amount due on the invoice for either unspecified reasons or for a specific reason such a dispute concerning a line item contained on the invoice.

2) The customer/buyer may elect to pay more than the amount due on the invoice.

3) The customer/buyer may elect to make a special payment, for example, an extra principal payment on a loan.

4) The customer/buyer may elect to change the date that the payment, via electronic transfer, will take place, provided that such date has not already passed.

5) The customer/buyer may change the source of funds for the payment, i.e., from a primary checking account to a pre-authorized credit card.

Making any of these changes discussed above requires that the customer/buyer be authorized to do so by the invoicer/seller.

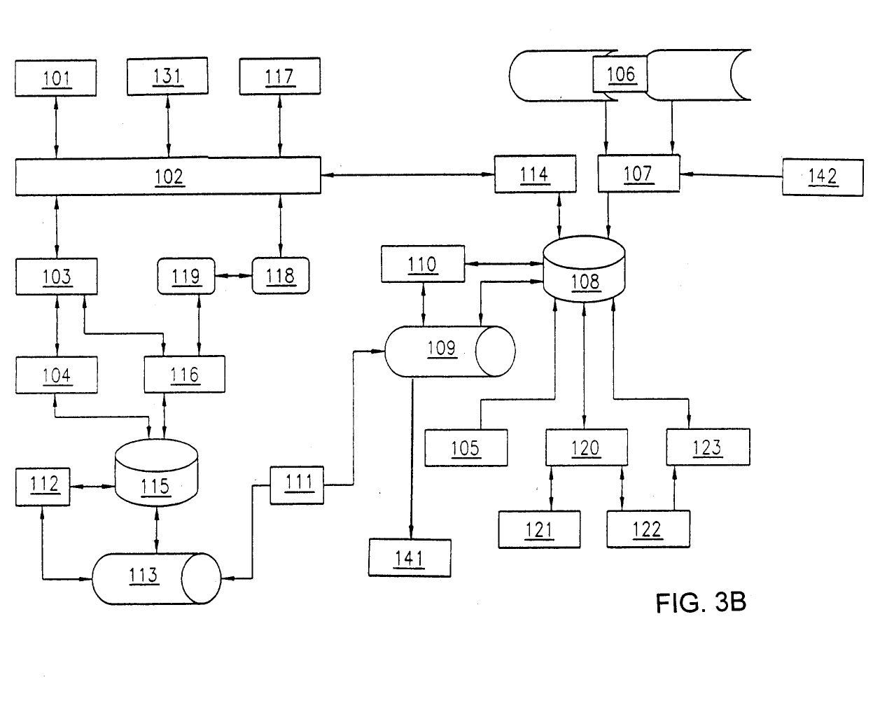

An automated electronic payment system is depicted schematically in FIG. 3A-1 which provides customer review of automated billing from an invoicer(s) to include: (a) invoice presentation electronics 60 adapted to present customer billing data in request for payment instructions related to automated billing, and (b) an electronic customer/buyer authorization interface 84.

The customer/buyer interface receives customer billing data from an invoicer(s)/seller(s) and request for payment instructions from the invoicer presentation electronics and provides those items to the customer/buyer. The interface also receives customer payment instructions in response to the request for payment instructions and transmits those instructions from the customer to payment electronics or payment source.

The invoice presentment electronics 60 may further include a control system 62 and first communication electronics 64. These components typically are located in a customer/buyer-controlled facility.

At a customer/buyer facility, the system includes an authorization terminal 80 having second communication electronics 82 adapted to communicate with first electronic communications 64. Control system 62 coordinates the generation of the electronic invoice 50 containing at least all the billing information normally included on a traditional paper invoice along with a request for payment instructions. Control system 62 then oversees the submission of that information from the first communication electronics 64 to the second communication electronics 82 for review by the customer/buyer.

Authorization terminal 80 is adapted to present the billing data to a customer/buyer and to appropriate a response relating to the billing data from the customer. The authorization terminal 80 may be remote from an invoicer/seller location. The response indicates acceptance of the billing data without change for automated payment or modification of the billing data as described above. The customer interface 84 is further adapted to transmit these payment instructions to invoice presentment electronics 60 and payment electronics 61.

Further more, control system 62 coordinates the receipt of payment instructions 52 containing at least invoicer/seller payment deposit number, a payment amount or a customer/buyer account number. Control system then oversees the submission of that information to the first communication electronics 64 from the second communication electronics 82.

The components of this system may be configured in a number of ways. For example, the customer/buyer accessible site may reside in an Internet website provided by customer/buyer for receiving the billing data and payment instructions from the customer/buyer and accessible by invoicer/seller for sending billing dating and receiving payment instruction from customer/buyer. The website will be accessible from the customer/buyer electronic authorization interface 84. In this instance, the customer/buyer authorization interface 84 would include an Internet browser.

Other alternatives for the electronic customer/buyer payment authorization interface include an automated teller machine (ATM), a remote kiosk, a personal computer, an interactive television device, or a telephone.

In the case of a telephone, the electronic customer/buyer authorization interface 84 could include either a well-known touch-tone telephone or a screen-based telephone.

In another embodiment, the electronic customer/buyer authorization interface 84 is a digital computer with the billing data and the payment request instructions presented by e-mail to the customer with an e-mail reply for relaying customer/buyer payment instructions 52 to the invoice presentation electronics 60. The electronic customer/buyer authorization interface 84 could also include a display for presenting billing data and the request for payment instructions along with a customer actuable input for receiving customer payment instructions.

In addition to the visual display, the electronic customer/buyer authorization interface 84 could further include audio electronics 85 and a speaker 86 for presenting billing data and request for payment instructions to the customer. In this embodiment, the customer actuable input for receiving customer payment instructions may also feature a customer-spoken input.

The electronic customer/buyer authorization interface 84 can receive payment instructions and associated information as customer actuable input, where the input may consist of a variety of electronic file means, such as, but not limited to EDI, ASCII, XML, text file formats, relaying payment instructions 52 to payment electronics 61 and invoice presentment electronics.

The electronic customer/buyer authorization interface 84 may also be adapted to allow a customer/buyer to poll the invoice presentment electronics 60 to receive billing data and payment request instructions.

The automated electronic payment system of the present invention includes submitting billing data from an invoicer(s)/seller(s) to a customer/buyer for customer/buyer review and acceptance/modification and the transmission of those items to the invoicer/seller. The billing information 50 that may be submitted to the customer includes any combination of the following items:

payment due date

amount due

detail of goods/services provided during a billing period

late charges

account information

customer information to include customer name, customer address, and customer account identifier (the account identifier could include a customer number and/or an account number)

invoice identifier, e.g., invoice number

The invoice presentment electronics 60 may include a memory device to store invoice information relating to customer/buyer bills. The payment electronics may include a memory device to store account information relating to financial institutions associated with the customer/buyer and payment accounts associated with invoicer(s)/seller(s). Through the payment electronics, the customer/buyer may have the option of selecting from a number of accounts a specific account from which funds are drafted to pay the invoice and to which payments may be made for invoicer/seller.

The memory device and the payment electronics 61 may also include information relating to a pre-authorized payment instruction for automated payment of the billing amount set from an account set out in the account information. If pre-authorized payment instructions are used, the request for payment instructions 50 originating in the invoice presentment electronics 60 may query the customer for acceptance of those instructions with or without modification. To accomplish such a modification, the customer authorization interface 84 may further include an editor for modifying the pre-authorized payment instructions.

The overall operation of the present invention can best be understood by referring to FIG. 3B. The customer/buyer can access the system through any remotely attached computing device 101 and communicate with the invoice and payment systems through a public or private network 102. A web server or communications processor of some kind 103 manages on-line communications between the customer/buyer and application systems. An invoicer/seller can access the system through any attached computing device 131 and communicates with the invoice and payment systems through a public or private network 102.

The invoicer/seller is presented electronic data input forms to complete by a provisioning application program 104 which also may validate whether the data input by the invoicer/seller is valid according to customer/buyer defined criteria or as contained in customer/buyer's Legacy systems. After determining whether invoicer/seller's records are accurate, the customer/buyer activates the invoicer for electronic invoice presentment and remittance presentment.

An electronic mail message or traditional letter may be sent to the invoicer(s)/seller(s) with information that allows the invoicer/seller to access the system, such as an account number and/or password.

Appropriate data, such as electronic invoice data 106 is acquired from invoicer(s)/seller(s). Electronic invoice data may be in a number of different formats, such as, but not limited to EDI, XML, ASCII, delimited formats or via a web interface where the invoicer/seller key enters invoice information.

Payment data 142, may optionally also be acquired from the customer/buyer. Payment data are records that are typically created by the customer/buyer that allow the customer/buyer to present payment instructions and remittance information and initiate payment to invoicer(s)/seller(s). Payment data may be in a number of different formats, such as, but not limited to EDI, XML, ASCII, delimited formats.

In acquiring the data for the product, data is sorted, parsed, extracted by an application program 107 and appropriate control data is maintained for reporting on operations. An application program 108 loads data into a relational database 109. In the preferred embodiment, two separate computers may be used for additional security over sensitive financial data such as account numbers or authorization codes. As a further security measure, the customer/buyer may choose to configure the product using a computer 110 located behind the customer/buyer's firewall security device and connected by a secured network 111 to the web server-hosting computer 112.

Invoice presentment data and subsets of data on financial arrangements are made available for presentment by transfer of data using immediate transfer, for example by way of an encrypted, remote stored procedure within the database 109 or by a batch transfer.

Once data to be made available electronically has been accurately loaded to the web server database 1 13, an application program 1 14 sends an electronic mail message to the customer/buyer announcing the availability of the invoice(s) and providing some summary of data. Since electronic mail account data may be invalid or services might be otherwise inoperative, the application program 114 is adapted to prepare data to be sent by the US Postal Service, fax or other means. A front-end processor 115 contains a template necessary to present the invoice and default payment arrangements 116 in the manner that the customer/buyer desires. The web server 103 hosts an interactive session in which the customer/buyer accesses their invoice. The customer/buyer may choose to modify pre-arranged payment arrangements. As an example, the customer/buyer may change the amount to pay, the date for payment and changing the source of funds for the payment, from a checking account to another source, such as a credit card. These arrangements 114 are stored on the web server database 113.

In the preferred embodiment, the invoicer(s)/seller(s) through their computing device 131, can view invoice and payment and remittance information, which is accessible through the front-end processor 115 for data stored on the web server database 113.

In the preferred embodiment, customer/buyer could also receive invoice data, stored in the relational database 109, extracted by an application program 141 and transmitted to the customer/buyer's own legacy system via a public or private network.

In the preferred embodiment, the customer/buyer could also use a telephone 117 connected to a network 102 and a PBX telephone processing switch 118 to pass data to and from a voice response unit 119. The customer could call into hear information about his invoice and signal changes to pre-existing arrangements, either through touch-tone entry or speech recognition. These changes are processed by the front end processor 115 and recorded in the data base just like remote-computer-based entries.

On each day that the customer/buyer transfers payment data to payment source, an application program 120 is executed to identify payment scheduled on the webserver database 113. Data from the web server is transferred for processing on the second computer 110 and combined with the data containing the payment arrangements, which was initially stored in the relational database 109. Based on the customer/buyer's instructions, records are modified or might be deleted and recreated if a change in funding source is requested. Payment data is then formatted to interface with the customer/buyer's payment source. For example, the payment source may be, but is not limited to, the customer/buyer's own Account's Payable system or their Financial Institution or a payment network.

Data 122 may be transferred to the customer/buyer's payment source. An application program 123 records those instances when payment data within a processing batch is returned for insufficient funds or incorrect account data so that the correct payment history for a customer/buyer and their invoicer(s)/seller(s) can be maintained.

The security provisions of the product allow a customer/buyer-focused delivery of electronic invoice presentment and payment arrangements. Although the preferred embodiment anticipates that an customer/buyer may choose to outsource web server hosting or web server and remittance processing to an outside company on their behalf, the service to customer/buyer and their invoicer(s)/seller(s) would be provided so that the customer/buyer and their invoicer(s)/seller(s) would not normally be aware that the customer/buyer was not actually operating the product directly. Certain modifications and improvements will occur to those skilled in the art upon a reading of the foregoing description. It should be understood that all such modifications and improvements have been deleted herein for the sake of conciseness and readability but are properly within the scope of the following claims.

Certain modifications and improvements will occur to those skilled in the art upon a reading of the foregoing description. By way of example, the customer/buyer may receive billing and request for payment from a plurality of invoicers/sellers, and, at the same time, an invoicer seller may present billing data and requests for payment to a plurality of customer/buyers. Also, notifications of availability of payment and remittance data may be sent to the invoicer(s)/seller(s), and the ability for the customer/buyer to send payment data only can be included. It should be understood that all such modifications and improvements have been deleted herein for the sake of conciseness and readability but are properly within the scope of the following claims.

We claim:

1. An automated electronic payment system wherein customer/buyer payment instructions are sent from a customer/buyer to a payment source, said system comprising:
(a) invoice presentation means adapted to present billing data from an invoicer/seller for customer/buyer review and to request payment from the customer/buyer; and
(b) an electronic customer/buyer payment interface having: (i) means for receiving the billing data and the request for payment from the invoicer/seller; (ii) means for providing the billing data for customer/buyer review and the request for payment to the customer/buyer; (iii) means for receiving customer/buyer payment instructions from the customer/buyer in response to the request for payment; and (iv) means for transmitting the customer/buyer payment instructions from the customer/buyer to the payment source, the payment instructions including at least an invoicer/seller deposit account number, a payment amount and a customer/buyer payment account number.

2. The system according to claim 1, further including an automated electronic invoicing and payment system for providing remote customer/buyer review of automated billing from an invoicer/seller, wherein the customer/buyer payment instructions are sent from the customer/buyer directly to the invoicer/seller.

3. The system according to claim 2, wherein said payment source is a clearing house.

4. The system according to claim 3, wherein said clearing house is a courier.

5. The system according to claim 3, wherein said clearing house is a payment network.

6. The system according to claim 2, wherein said payment instructions include transmission date.

7. The system according to claim 2, wherein said payment instructions include amount to draft from customer associated financial institution.

8. The system according to claim 2, wherein said payment instructions include account information associated with the customer/buyer from which to draft payment.

9. The system according to claim 2, wherein said payment instructions include account information associated with the invoicer from which to deposit payment.

10. The system according to claim 1, wherein said billing data includes invoicer billing information.

11. The system according to claim 10, wherein said billing data includes a due date.

12. The system according to claim 10, wherein said billing data includes an amount due.

13. The system according to claim 10, wherein said billing data includes a list of goods or services provided during a billing period.

14. The system according to claim 10, wherein said billing data includes a late charge.

15. The system according to claim 10, wherein said billing data includes account information.

16. The system according to claim 1, wherein said billing data includes customer/buyer information.

17. The system according to claim 16, wherein said customer/buyer information includes customer name.

18. The system according to claim 16, wherein said customer/buyer information includes customer address.

19. The system according to claim 16, wherein said customer/buyer information includes account information for the customer.

20. The system according to claim 1, wherein said billing data includes a customer/buyer account identifier.

21. The system according to claim 1, wherein said billing data includes an invoice identifier.

22. The system according to claim 1, wherein said invoice presentation means includes invoice information relating to customer/buyer bills and account information relating to financial institutions associated with the customer/buyer from which payments may be drafted.

23. The system according to claim 22, wherein said invoice presentation means further includes preauthorized payment instructions for automated payment of a billing amount set out in said billing information from an account set out in said account information.

24. The system according to claim 23, wherein the request for payment instructions from said invoice presentation means queries the customer/buyer if the preauthorized payment instructions are desired for the billing data presented.

25. The system according to claim 23, wherein the request for payment instructions from said invoice presentation means queries the customer/buyer if the preauthorized payment instructions need modification for the billing data presented.

26. The system according to claim 23, wherein said customer/buyer payment interface includes an editor for modifying the preauthorized payment instructions.

27. The system according to claim 22, wherein the account information includes account information from a plurality of financial institutions and the request for payment queries the customer to select the financial institution from which to draft payment for an associated customer/buyer bill.

28. The system according to claim 27, wherein said invoice presentation means includes a preauthorized default identifying the financial institution from which to draft payment for said associated customer/buyer bill.

29. The system according to claim 28, wherein said electronic customer/buyer payment interface is adapted to receive a customer/buyer input to accept the preauthorized default.

30. The system according to claim 28, wherein said electronic customer/buyer payment interface is adapted to receive a customer/buyer input to modify the preauthorized default.

31. The system according to claim 1, wherein said request for payment includes billing information selected from the group consisting of amount due, due date, account from which to draft payment.

32. The system according to claim 31, wherein said customer/buyer payment interface is adapted to modify the billing information to change one or more of the group consisting of amount due, time of payment and account from which to draft payment.

33. The system according to claim 1, wherein said billing data include notices for the customer.

34. The system according to claim 1, wherein said billing data include advertising information directed towards the customer.

35. The system according to claim 1, wherein said billing data include control information.

36. An automated electronic customer/buyer payment interface for an automated electronic payment system for providing customer/buyer review of billing from an invoicer/seller, said system comprising:
(a) means for receiving billing data and a request for payment from said invoicer/seller;
(b) means for providing the billing data for customer/buyer review and the request for payment to the customer/buyer;
(c) means for receiving customer/buyer payment instructions from the customer/buyer in response to the request for payment;
(d) means for transmitting the customer/buyer payment instructions from the customer/buyer to a payment source, said payment instructions including at least a invoicer/seller deposit account number, a payment amount and a customer/buyer payment account number; and
(e) means for providing remittance data associated with the payment from the customer/buyer to said invoicer/seller.

37. The system as claimed in claim 36 wherein said means for receiving billing data includes at least one of the group consisting of an XML file, an EDI file, a text file, and a web e-form.

38. The system as claimed in claim 36 wherein said means for providing the billing data includes at least one of the group consisting of an XML file, an EDI file, a text file, and a web e-form.

39. The system as claimed in claim 36 wherein said means for receiving customer/buyer payment instructions includes at least one of the group consisting of an XML file, an EDI file, a text file, and a web e-form.

40. The system as claimed in claim 36 wherein said means for transmitting the customer/buyer payment instructions includes a network and a network interface.

41. The system as claimed in claim 40 wherein said network and said network interface includes a public network.

42. The system as claimed in claim 41 wherein said public network includes the Internet.

43. The system as claimed in claim 40 wherein said network and said network interface includes a private network.

44. The system as claimed in claim 43 wherein said private network includes a VPN.

45. The system as claimed in claim 43 wherein said private network includes a VAN.

46. The system as claimed in claim 36 wherein said means for providing remittance data includes at least one of the group consisting of an XML file, an EDI file, a text file, and a web e-form.

47. The system as claimed in claim 46 wherein said means for providing remittance data further includes a network and a network interface.

48. The system as claimed in claim 47 wherein said network and said network interface includes a public network.

49. The system as claimed in claim 48 wherein said public network includes the Internet.

50. The system as claimed in claim 47 wherein said network and said network interface includes a private network.

51. The system as claimed in claim 50 wherein said private network includes a VPN.

52. The system as claimed in claim 50 wherein said private network includes a VAN.

53. An automated electronic payment system wherein customer/buyer payment instructions are sent from a customer/buyer to a payment source, said system comprising:
(a) invoice presentation means adapted to present billing data from an invoicer/seller for customer/buyer review and to request payment from the customer/buyer;
(b) an electronic customer/buyer payment interface having: (i) means for receiving the billing data and the request for payment from the invoicer/seller; (ii) means for providing the billing data for customer/buyer review and the request for payment to the customer/buyer; (iii) means for receiving customer/buyer payment instructions from the customer/buyer in response to the request for payment; (iv) means for transmitting the customer/buyer payment instructions from the customer/buyer to the payment source, the payment instructions including at least an invoicer/seller deposit account number, a payment amount and a customer/buyer payment account number; and (v) means for providing remittance data associated with said payment from said customer/buyer to said invoicer/seller; and
(c) an automated electronic invoicing and payment system for providing remote customer/buyer review of automated billing from an invoicer/seller, wherein the customer/buyer payment instructions are sent from the customer/buyer directly to the invoicer/seller.

54. The system according to claim 53, wherein said payment source is a clearing house.

55. The system according to claim 54, wherein said clearing house is a courier.

56. The system according to claim 54, wherein said clearing house is a payment network.

57. The system according to claim 53, wherein said payment instructions include transmission date.

58. The system according to claim 53, wherein said payment instructions include amount to draft from customer associated financial institution.

59. The system according to claim 53, wherein said payment instructions include account information associated with the customer/buyer from which to draft payment.

60. The system according to claim 53, wherein said payment instructions include account information associated with the invoicer from which to deposit payment.

61. The system according to claim 53, wherein said billing data includes invoicer billing information.

62. The system according to claim 61, wherein said billing data includes a due date.

63. The system according to claim 61, wherein said billing data includes an amount due.

64. The system according to claim 61, wherein said billing data includes a list of goods or services provided during a billing period.

65. The system according to claim 61, wherein said billing data includes a late charge.

66. The system according to claim 61, wherein said billing data includes account information.

67. The system according to claim 53, wherein said billing data includes customer/buyer information.

68. The system according to claim 67, wherein said customer/buyer information includes customer name.

69. The system according to claim 67, wherein said customer/buyer information includes customer address.

70. The system according to claim 53, wherein said customer/buyer information includes account information for the customer.

71. The system according to claim 53, wherein said billing data includes a customer/buyer account identifier.

72. The system according to claim 53, wherein said billing data includes an invoice identifier.

73. The system according to claim 53, wherein said invoice presentation means includes invoice information relating to customer/buyer bills and account information relating to financial institutions associated with the customer/buyer from which payments may be drafted.

74. The system according to claim 73, wherein said invoice presentation means further includes preauthorized payment instructions for automated payment of a billing amount set out in said billing information from an account set out in said account information.

75. The system according to claim 74, wherein the request for payment instructions from said invoice presentation means queries the customer/buyer if the preauthorized payment instructions are desired for the billing data presented.

76. The system according to claim 74, wherein the request for payment instructions from said invoice presentation means queries the customer/buyer if the preauthorized payment instructions need modification for the billing data presented.

77. The system according to claim 74, wherein said customer/buyer payment interface includes an editor for modifying the preauthorized payment instructions.

78. The system according to claim 73, wherein the account information includes account information from a plurality of financial institutions and the request for payment queries the customer to select the financial institution from which to draft payment for an associated customer/buyer bill.

79. The system according to claim 78, wherein said invoice presentation means includes a preauthorized default identifying the financial institution from which to draft payment for said associated customer/buyer bill.

80. The system according to claim 79, wherein said electronic customer/buyer payment interface is adapted to receive a customer/buyer input to accept the preauthorized default.

81. The system according to claim 79, wherein said electronic customer/buyer payment interface is adapted to receive a customer/buyer input to modify the preauthorized default.

82. The system according to claim 53, wherein said request for payment includes billing information selected from the group consisting of amount due, due date, account from which to draft payment.

83. The system according to claim 82, wherein said customer/buyer payment interface is adapted to modify the billing information to change one or more of the group consisting of amount due, time of payment and account from which to draft payment.

84. The system according to claim 53, wherein said billing data include notices for the customer.

85. The system according to claim 53, wherein said billing data include advertising information directed towards the customer.

86. The system according to claim 53, wherein said billing data include control information.

87. The system as claimed in claim 53 wherein said means for receiving billing data includes at least one of the group consisting of an XMLfile, an EDI file, a text file, and a web e-form.

88. The system as claimed in claim 53 wherein said means for providing the billing data includes at least one of the group consisting of an XML file, an EDI file, a text file, and a web e-form.

89. The system as claimed in claim 53 wherein said means for receiving customer/buyer payment instructions includes at least one of the group consisting of an XML file, an EDI file, a text file, and a web e-form.

90. The system as claimed in claim 53 wherein said means for transmitting the customer/buyer payment instructions includes a network and a network interface.

91. The system as claimed in claim 90 wherein said network and said network interface includes a public network.

92. The system as claimed in claim 91 wherein said public network includes the Internet.

93. The system as claimed in claim 90 wherein said network and said network interface includes a private network.

94. The system as claimed in claim 93 wherein said private network includes a VPN.

95. The system as claimed in claim 93 wherein said private network includes a VAN.

96. The system as claimed in claim 53 wherein said means for providing remittance data includes at least one of the group consisting of an XML file, an EDI file, a text file, and a web e-form.

97. The system as claimed in claim 96 wherein said means for providing remittance data further includes a network and a network interface.

98. The system as claimed in claim 97 wherein said network and said network interface includes a public network.

99. The system as claimed in claim 98 wherein said public network includes the Internet.

100. The system as claimed in claim 97 wherein said network and said network interface includes a private network.

101. The system as claimed in claim 100 wherein said private network includes a VPN.

102. The system as claimed in claim 100 wherein said private network includes a VAN.

103. A computerized method for automated electronic payment wherein customer/buyer payment instructions are sent from a customer/buyer to a payment source, said method comprising the steps of:
(a) presenting billing data from an invoicer/seller for customer/buyer review and to request payment from the customer/buyer; and
(b) receiving the billing data and the request for payment from the invoicer/seller;
(c) providing the billing data for customer/buyer review and the request for payment to the customer/buyer;
(d) receiving customer/buyer payment instructions from the customer/buyer in response to the request for payment; and
(e) transmitting the customer/buyer payment instructions from the customer/buyer to the payment source, the payment instructions including at least an invoicer/seller deposit account number, a payment amount and a customer/buyer payment account number.

104. A computerized method for an automated electronic customer/buyer payment interface for an automated electronic payment system for providing customer/buyer review of billing from an invoicer/seller, said method comprising the steps of:
(a) receiving billing data and a request for payment from said invoicer/seller;
(b) providing the billing data for customer/buyer review and the request for payment to the customer/buyer;
(c) receiving customer/buyer payment instructions from the customer/buyer in response to the request for payment;
(d) transmitting the customer/buyer payment instructions from the customer/buyer to a payment source, said payment instructions including at least a invoicer/seller deposit account number, a payment amount and a customer/buyer payment account number; and
(e) providing remittance data associated with the payment from the customer/buyer to said invoicer/seller.

105. A computerized method for automated electronic payment system wherein customer/buyer payment instructions are sent from a customer/buyer to a payment source, said method comprising the steps of:
(a) presenting billing data from an invoicer/seller for customer/buyer review and to request payment from the customer/buyer;
(b) receiving the billing data and the request for payment from the invoicer/seller;
(c) providing the billing data for customer/buyer review and the request for payment to the customer/buyer;
(d) receiving customer/buyer payment instructions from the customer/buyer in response to the request for payment;
(e) transmitting the customer/buyer payment instructions from the customer/buyer to the payment source, the payment instructions including at least an invoicer/seller deposit account number, a payment amount and a customer/buyer payment account number; and (v) provide remittance data associated with said payment from said customer/buyer to said invoicer/seller; and
(f) providing remote customer/buyer review of automated billing from an invoicer/seller, wherein the customer/buyer payment instructions are sent from the customer/buyer directly to the invoicer/seller.
